(19) United States
(12) Patent Application Publication
(10) Pub. No.: US 2026/0112921 A1
(43) Pub. Date: Apr. 23, 2026

(54) INITIAL CHARGING CIRCUIT, POWER FEEDING APPARATUS, AND ENERGY HARVESTING DEVICE

(71) Applicant: Asahi Kasei Microdevices Corporation, Tokyo (JP)

(72) Inventor: Shiro TAGA, Tokyo (JP)

(21) Appl. No.: 19/359,719

(22) Filed: Oct. 16, 2025

(30) Foreign Application Priority Data
Oct. 23, 2024 (JP) 2024-186966

(51) Int. Cl. H02J 50/00; H02J 7/34

(52) U.S. Cl. CPC H02J 50/001; H02J 7/342; H02J 7/345; H02J 2207/50

(57) ABSTRACT

Provided is an initial charging circuit which controls a current flowing between a first power storage element and a second power storage element, the initial charging circuit including: a resistance portion whose one end is connected to the first power storage element; a first transistor whose one end is connected to another end of the resistance portion and whose another end is connected to the second power storage element; and an operational amplifier whose output terminal is connected to a control terminal of the first transistor and which varies an amount of current flowing between the first power storage element and the second power storage element, based on a difference between a reference voltage and a voltage at a node between the one end of the first transistor and the another end of the resistance portion.

The contents of the following patent application(s) are incorporated herein by reference:

NO. 2024-186966 filed in JP on Oct. 23, 2024.

### BACKGROUND

### 1. Technical Field

The present invention relates to an initial charging circuit, a power feeding apparatus, and an energy harvesting device.

### 2. Related Art

Patent Document 1 describes an environment monitoring system 1 “configured with a power storage system 100 that accumulates, in a storage electric cell, electrical power generated by a power generation element that carries out environmental power generation; and an external load apparatus 200 to which power is fed from the power storage system 100” (paragraph 0021). It is indicated that “in a power storage system according to the present embodiment, to solve the abovementioned problem, a storage electric cell A121and a storage electric cell B122 of two types having different capacities and a switch portion 140 (a first switch portion) serving as a switching mechanism are used”(paragraph [0024]).

Patent Document 1: WO 2015/099158

### BRIEF DESCRIPTION OF THE DRAWINGS

FIG. 1 is a drawing showing an example of an energy harvesting device 100 including an initial charging circuit 30 according to an embodiment of the present invention.

FIG. 2 is a drawing showing an example of the initial charging circuit 30 according to the embodiment of the present invention.

FIG. 3 is a drawing showing a variant of the initial charging circuit 30 according to the embodiment.

FIG. 4 is a drawing showing another variant of the initial charging circuit 30 according to the embodiment.

FIG. 5 is a drawing showing a configuration example of a voltage divider circuit 34.

FIG. 6 is a drawing showing an example of temporal changes in each voltage of the energy harvesting device 100 in FIG. 1.

FIG. 7 is a drawing showing another example of the energy harvesting device 100.

FIG. 8 is a flowchart for explaining an operation of the energy harvesting device 100 in FIG. 7.

FIG. 9 is a graph showing temporal changes in voltage of each node and in operations of different parts.

FIG. 10 is a drawing showing a variant of the energy harvesting device 100 shown in FIG. 7.

FIG. 11 is a drawing showing another variant of the initial charging circuit 30.

FIG. 12 is a drawing showing yet another variant of the initial charging circuit 30.

### DESCRIPTION OF EXEMPLARY EMBODIMENTS

Hereinafter, the invention will be described through embodiments of the invention, but the following embodiments do not limit the invention according to claims. In addition, not all combinations of features described in the embodiments are essential to a solution of the invention.

In the present specification, a case where a term such as “same” or “equal” is mentioned may include a case where an error due to a variation in manufacturing or the like is included. The error is, for example, within 10%. In addition, in the present specification, phrases such as “connected between . . . and . . . ”, “provided between . . . and . . . ”, or “arranged between . . . and . . . ” shall mean “electrically connected to . . . and . . . ” rather than limiting physical arrangement.

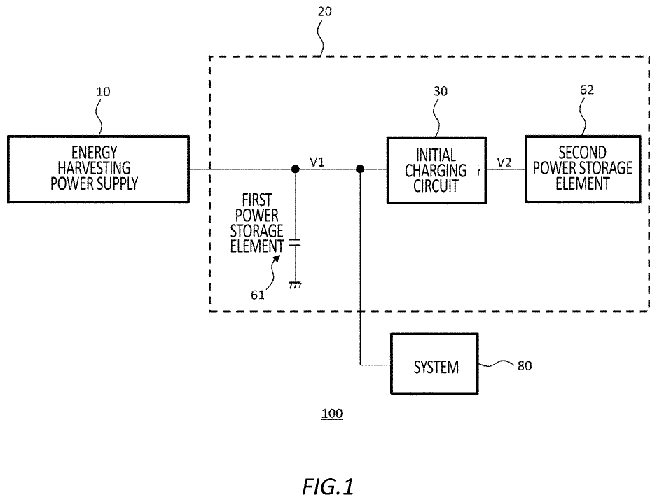

FIG. 1 is a drawing showing an example of an energy harvesting device 100 including an initial charging circuit 30 according to an embodiment of the present invention. The energy harvesting device 100 includes an energy harvesting power supply 10, a power feeding apparatus 20, and a system 80.

The energy harvesting power supply 10 may be configured with one or more power supplies realizing solar power generation, vibration power generation, electromagnetic wave power feeding, or the like. When voltage output by these power supplies is too low or too high, the energy harvesting power supply 10 may include a boost converter or a step-down converter.

The system 80 is driven with electrical power generated by the energy harvesting power supply 10. For example, the system 80 is an IoT apparatus configured with: a sensor that converts a physical quantity of a temperature, a luminance, a carbon dioxide gas concentration, an alcohol concentration, a smell, or the like into an electrical signal; a microcomputer that processes the obtained electrical signal; and a device, for example, a BLUETOOTH (registered trademark) communication device, that communicates with an outside.

The power feeding apparatus 20 is provided between the energy harvesting power supply 10 and the system 80. The electrical power obtained by the energy harvesting power supply 10 is usually small or temporally unstable. For this reason, to stably operate the system 80, the electrical power is temporarily stored in a power storage element such as a capacitor or a battery of the power feeding apparatus 20 and is supplied to the system 80 from the power storage element.

However, in an example using a secondary electric cell such as a lithium ion battery, once the electrical power is all discharged, it takes an extremely long period of time, due to a large capacity, to restore voltage that makes the system 80 operable. During that time period, the system 80 is not able to operate. For this reason, the power feeding apparatus 20 in the present example includes a first power storage element 61 and a second power storage element 62 having a larger capacity than the first power storage element 61. The first power storage element 61 is an element having a relatively small electrical capacity, such as a ceramic capacitor or a supercapacitor, for example. The second power storage element 62 is an element having a relatively large electrical capacity like a secondary electric cell such as a nickel hydrogen electric cell, a lithium ion battery, or the like, for example.

To compare capacities, for capacitors, capacitances (F) may be compared; for batteries, capacities (Ah) of electric cells may be compared. Further, it is acceptable to assume that the electrical capacity of a battery is larger than the electrical capacity of a capacitor. It is also acceptable to compare an electrical charge (C) obtained by multiplying a capacitance of a capacitor by a rated voltage with a capacity (Ah=C) of an electric cell.

The first power storage element 61 is charged with the electrical power from the energy harvesting power supply 10. Further, the second power storage element 62 is charged with electrical power from the first power storage element 61. At least one of the first power storage element 61 or the second power storage element 62 supplies electrical power to the system 80 existing externally. With this configuration, the power feeding apparatus 20 drives the system 80, by charging the first power storage element 61 so as to quickly increase a voltage V1 to be supplied to the system 80 to a voltage that makes the system 80 operable. The voltage V1 is an output voltage of the first power storage element 61. A voltage V2 is an output voltage of the second power storage element 62.

The power feeding apparatus 20 includes an initial charging circuit 30. The initial charging circuit 30 is provided between the first power storage element 61 and the second power storage element 62 and controls a current flowing between the first power storage element 61 and the second power storage element 62. The initial charging circuit 30 may cause a current to flow from the first power storage element 61 toward the second power storage element 62 to charge the second power storage element 62. For example, the current is caused to flow toward the second power storage element 62 only when the voltage V1 of the first power storage element 61 is higher than a minimum voltage to make the system 80 operable. With this configuration, it is possible to keep the electrical power from the energy harvesting power supply 10 stored. When an output of the energy harvesting power supply 10 is unstable or when more electrical power is needed, it is possible to supply electrical power to the system 80 for a long period of time, by supplying the electrical power from the second power storage element 62.

When the initial charging circuit 30 is off, the first power storage element 61 may supply electrical power only to the system 80. A connection point of the system 80 and the power feeding apparatus 20 may be between the energy harvesting power supply 10 with the first power storage element 61 and the initial charging circuit 30. In other words, the electrical power supplied from the energy harvesting power supply 10 and the first power storage element 61 may be supplied to the system 80 without going through the initial charging circuit 30. Note that, in the present specification, the electrical power supplied from a power storage element to the system 80 or the electrical power supplied from the first power storage element 61 to the second power storage element 62 may also include the electrical power generated by the energy harvesting power supply 10.

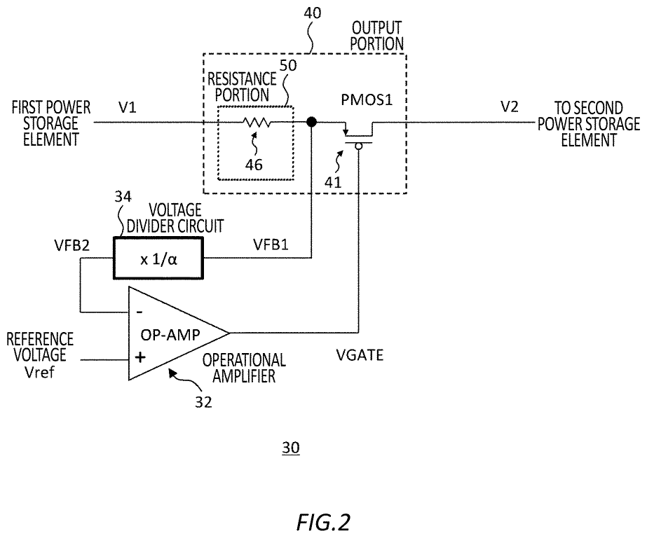

FIG. 2 is a drawing showing an example of the initial charging circuit 30 according to the embodiment of the present invention. The initial charging circuit 30 may include an output portion 40 and an operational amplifier 32. The initial charging circuit 30 may further include a voltage divider circuit 34.

The output portion 40 is provided between the first power storage element 61 and the second power storage element 62 and controls the current flowing between the first power storage element 61 and the second power storage element according to an output of the operational amplifier 32. The output portion 40 in the present example includes a first transistor 41 and a resistance portion 50. As for the first transistor 41, one end thereof is connected to the first power storage element 61, and another end thereof is connected to the second power storage element 62. In the present specification, when two elements are described as being “connected”, the description may denote a state in which the two elements are directly connected by a wiring or may denote a state in which the two elements are indirectly connected while a resistance element is interposed. Being “connected” may include a state in which two elements are indirectly connected while an element other than a resistor is interposed. The first transistor 41 in the present example is a P type MOSFET whose source is connected to the resistance portion 50 and whose drain is connected to the second power storage element 62. A gate of the first transistor 41 is connected to an output of the operational amplifier 32.

The resistance portion 50 is provided between the first transistor 41 and the first power storage element 61. As for the resistance portion 50 in the present example, one end thereof is connected to the first power storage element 61, and another end thereof is connected to the source (the one end) of the first transistor 41. The resistance portion 50 in the present example includes a resistor 46.

The operational amplifier 32 varies an amount of current flowing between the first power storage element 61 and the second power storage element 62, based on a difference between a voltage VFB1 at the one end (the source) of the first transistor 41 and a reference voltage Vref. The voltage VFB1 may be a voltage at a node between the one end of the first transistor 41 and the another end of the resistance portion 50. In other words, the amount of current flowing through the first transistor 41 varies according to a change in an output voltage VGATE of the operational amplifier 32. Based on the difference between the voltage VFB1 and the reference voltage Vref, the operational amplifier 32 may vary an amount of current flowing between the first power storage element 61 and the second power storage element 62 while the first transistor 41 is in an ON state. The amount of current flowing through the first transistor 41 may exhibit a plurality of values according to values of the output voltage VGATE. When a voltage value of the output voltage VGATE continuously varies, the amount of current flowing through the first transistor 41 may also continuously vary. When a voltage value of the output voltage VGATE discretely varies, the current value flowing through the first transistor 41 may also discretely vary. The operational amplifier 32 may output the output voltage VGATE whose voltage value continuously varies or may output the output voltage VGATE whose voltage value discretely varies. The operational amplifier 32 in the present example is an op-amp to which the reference voltage Vref is input through a positive input terminal and to which a feedback voltage VFB2 is input through a negative input terminal. The reference voltage Vref is, for example, an output voltage of a bandgap reference voltage generation circuit. The operational amplifier 32 does not need to include a comparator. The output voltage VGATE of the operational amplifier 32 is output to the gate of the first transistor 41. The operational amplifier 32 may control the amount of current flowing through the first transistor 41, by varying the output voltage VGATE based on the difference between the voltage VFB2 and the reference voltage Vref in a saturation region of the first transistor 41.

The voltage divider circuit 34 in the present example is provided between one end (a source terminal in the present example) of the first transistor 41 and the negative input terminal of the operational amplifier 32. The source voltage VFB1 of the first transistor 41 is multiplied by 1/α by the voltage divider circuit 34 so as to be input as the feedback voltage VFB2 to the negative input terminal of the operational amplifier 32. As a result of the operational amplifier 32 operating based on the difference between the feedback voltage VFB2 and the reference voltage Vref, the operational amplifier 32 operates based on the difference between the voltage VFB1 at the one end (the source) of the first transistor 41 and the reference voltage Vref. In the present specification, being based on the difference between the voltage VFB1 at the one end of the first transistor 41 and the reference voltage Vref may be expressed as being based on a difference between the voltage VFB1 at the one end of the first transistor 41 and α×Vref.

By using a feedback loop configured with the operational amplifier 32, the output portion 40, and the voltage divider circuit 34, the initial charging circuit 30 in FIG. 2 causes the current to flow from the first power storage element 61 to the second power storage element 62 so as to charge the second power storage element 62, without lowering the voltage V1 of the first power storage element 61 to be lower than α×Vref. More specifically, when the voltage V1 of the first power storage element 61 is lower than α×Vref, the output VGATE of the operational amplifier 32 in the present example has increased close to the voltage V1, and the first transistor 41 does not cause the current to flow from the first power storage element 61 to the second power storage element 62. When sufficient electrical power is supplied from the energy harvesting power supply 10 so that the charging of the first power storage element 61 advances, and the voltage V1 of the first power storage element 61 becomes equal to or higher than α×Vref, the operational amplifier 32 in the present example lowers the output voltage VGATE and turns the first transistor 41 on. The larger the difference between the voltage V1 and α×Vref becomes, the larger becomes a decrease amount of the output voltage VGATE. In conjunction therewith, the current flowing from the first power storage element 61 to the second power storage element 62 increases, and the voltage V1 of the first power storage element 61 decreases. When the voltage V1 of the first power storage element 61 falls, the decrease amount of the output voltage VGATE becomes smaller. In conjunction therewith, the current flowing from the first power storage element 61 to the second power storage element 62 decreases, and the fall of the voltage V1 of the first power storage element 61 is mitigated.

For example, if the first transistor 41 repeatedly turned on/off like in Patent Document 1, ripple power supply noise would occur in the output voltage to the system 80. As a result of the operational amplifier 32 varying the current flowing through the first transistor 41 like in the present example, it is possible to cause the current to flow from the first power storage element 61 to the second power storage element 62 so as to charge the second power storage element 62, without causing the ripple power supply noise.

In this situation, the stability of the feedback loop is influenced by the poles and zeros of the open-loop transfer function that forms the loop. The loop tends to become unstable due to phase delays caused by pole P1 in the operational amplifier 32 and pole P2 in the output portion 40. In this situation, for example, the pole P1 occurs due to an output resistance Rop of the operational amplifier 32 and a parasitic capacitance Cop (not shown) driven by the output voltage VGATE of the operational amplifier 32 and may be calculated as P1=1/(2π×Rop×Cop) (Hz). The pole P2 occurs due to a transconductance Gm1 of the first transistor 41 and a capacitance C1 of the first power storage element 61 and may be calculated as P2=Gm1/(2π×C1) (Hz).

Further, a resistance value R1 of the resistance portion 50 (a resistance value of the resistor 46 in the example in FIG. 2) and the capacitance C1 of the first power storage element 61 form a zero Z1 which causes a phase lead, and it is possible to mitigate an effect of the pole P2. The zero Z1 may be calculated as Z1=1/(2π×R1×C1) (Hz). Selecting the resistance value R1 so that the pole P2 and the zero point Z1 have nearly equal values or satisfy P2>Z1 secures stability of the feedback loop.

In this situation, the transconductance Gm1 of the first transistor 41 structuring the pole P2 increases when the current flowing from the first power storage element 61 to the second power storage element 62 increases and decreases when the current decreases. Accordingly, based on the above expression, the frequency of pole P2 also becomes higher as the current increases and becomes lower as the current decreases. As explained above, when the pole P2 and the zero Z1 have nearly equal values or satisfy the relationship P2>Z1, the stability of the feedback loop is secured. Thus, when the pole P2 becomes higher due to a current increase, there is flexibility to adjust the zero Z1 to be able to become higher. According to the above expression, because the zero Z1 includes the resistance value R1 of the resistance portion 50 in the denominator thereof, when the resistance value R1 decreases, the zero Z1 becomes higher. In other words, when the current increases, there is flexibility to adjust the resistance value R1 to be able to decrease. Note that, in order to satisfy the abovementioned relationship between the pole P2 and the zero Z1, it is desirable that the resistance value R1 increases when the current decreases.

Further, if the resistance value R1 of the resistor 46 shown in FIG. 2 is fixed, a voltage drop caused by a current flowing through the resistance portion 50 increases as the current increases and causes heat loss, which lowers charging efficiency. For this reason, from a viewpoint of the charging efficiency, it is desirable that the resistance value R1 of the resistance portion 50 decreases when the current increases. To summarize, by ensuring that the resistance value R1 decreases as the current increases and increases as the current decreases, it is possible to prevent degradation of the charging efficiency, while securing stability of the feedback loop. When the current flowing through the resistance portion 50 is small, the resistance value of the resistance portion 50 may increase, and when the current flowing through the resistance portion 50 is large, the resistance value of the resistance portion 50 may decrease. In other words, the resistance value of the resistance portion 50 when the current flowing through the resistance portion 50 has a first amount of current may be smaller than the resistance value of the resistance portion 50 when the current flowing through the resistance portion has a second amount of current smaller than the first amount of current.

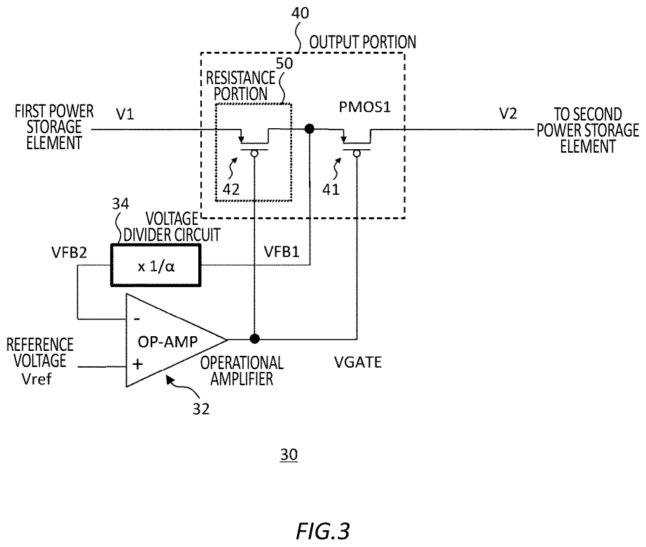

FIG. 3 is a drawing showing a variant of the initial charging circuit 30 according to the embodiment. The initial charging circuit 30 in the present example is different from the initial charging circuit 30 shown in FIG. 2 in that the resistance portion 50 includes a second transistor 42.

The second transistor 42 in the present example is a P type MOSFET. A drain of the second transistor 42 is connected to the source of the first transistor 41, and a source of the second transistor 42 is connected to the first power storage element 61.

Together with the gate of the first transistor 41, a gate of the second transistor 42 is connected to an output of the operational amplifier 32, and together receive an input of the output voltage VGATE. In other words, the operational amplifier 32 varies an ON resistance of the second transistor 42, based on the difference between the voltage VFB1 at the one end of the first transistor 41 and α×Vref. The operational amplifier 32 may vary the ON resistance occurring while the second transistor 42 is in an ON state, based on the difference between the voltage VFB1 and α×Vref. The second transistor 42 may operate in a linear region.

An absolute value of a threshold voltage of the second transistor 42 may be larger than an absolute value of a threshold voltage of the first transistor 41. For example, a threshold voltage VTP2 of the second transistor 42 may be −0.6 V, and a threshold voltage VTP1 of the first transistor 41 may be −0.4 V.

When the voltage V1 of the first power storage element increases or decreases, the feedback loop of the initial charging circuit 30 controls the output voltage VGATE so that the feedback voltage VFB2 approaches the reference voltage Vref and controls the current flowing from the first power storage element 61 into the second power storage element 62 via the first transistor 41 and the second transistor 42 so that the source voltage VFB1 of the first transistor 41 becomes equal to α×Vref.

In the initial charging circuit 30 in the present example, the resistance value R1 of the resistance portion 50 which determines the zero Z1 is an ON resistance of the second transistor 42. The ON resistance is controlled by the output voltage VGATE of the operational amplifier 32. When the current flowing from the first power storage element 61 into the second power storage element 62 decreases (or when small), the output voltage VGATE increases, and the ON resistance increases. When the inflow current increases (or when large), the output voltage VGATE decreases, and the ON resistance decreases. In other words, as the current decreases, the zero Z1 becomes lower. As the current increases, the zero Z1 becomes higher.

Further, similarly with the transconductance Gm1 of the first transistor 41 which determines the pole P2, when the current flowing from the first power storage element 61 into the second power storage element 62 decreases (or when small), the output voltage VGATE increases, the transconductance Gm1 decreases, and the pole P2 also becomes lower. In contrast, when the inflow current increases (or when large), the output voltage VGATE decreases, the transconductance Gm1 increases, and the pole P2 also becomes higher. With this configuration, according to the current flowing from the first power storage element into the second power storage element, the pole P2 and the zero point Z1 change in the same increase/decreasing direction to secure stability. In addition, when the current is large, the ON resistance of the second transistor 42 decreases, and it is possible to prevent degradation of the charging efficiency that may be caused by a voltage drop.

The second transistor 42 in the present example is a P type MOSFET; however, the second transistor 42 may be an N type MOSFET. A conductivity-type of the first transistor 41 may be the same as a conductivity-type of the second transistor 42.

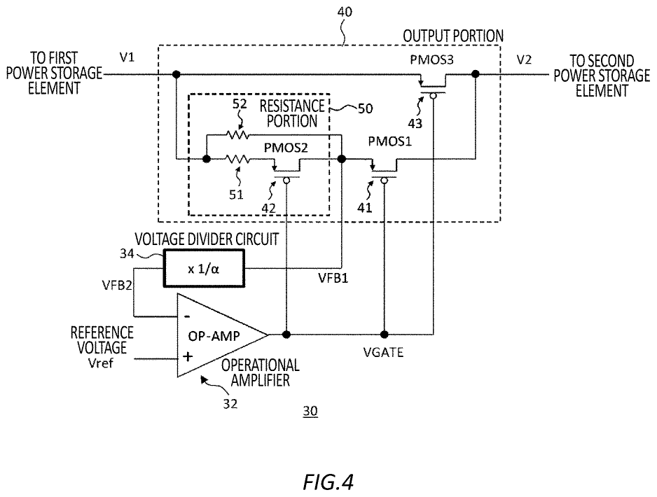

FIG. 4 is a drawing showing another variant of the initial charging circuit 30 according to the embodiment. In addition to the configuration of the variant in FIG. 3, the initial charging circuit 30 in FIG. 4 includes a third transistor 43 in the output portion 40. Further, in addition to the configuration of the variant in FIG. 3, the resistance portion 50 in the present example includes a first resistor 51 and a second resistor 52.

As for the third transistor 43, one end thereof is connected to the first power storage element 61, and another end thereof is connected to the second power storage element 62. Further, the first transistor 41 and the resistance portion 50 are connected in parallel to the third transistor 43. The third transistor 43 in the present example is a P type MOSFET. As for the third transistor 43 in the present example, a drain thereof is connected to the second power storage element 62, and a source thereof is connected to the first power storage element 61.

Together with the gate of the first transistor 41 and the gate of the second transistor 42, a gate of the third transistor 43 is connected to an output of the operational amplifier 32, and together receive an input of the output voltage VGATE. In other words, the operational amplifier 32 varies an amount of current flowing between the first power storage element 61 and the second power storage element 62, based on the difference between the voltage VFB1 at the one end of the first transistor 41 and α×Vref. The abovementioned amount of current may be an amount of current flowing from the drain to the source of the third transistor 43. The operational amplifier 32 may vary the amount of current occurring while the third transistor 43 is in an ON state, based on the difference between the voltage VFB1 and α×Vref.

Because the first transistor 41 and the second transistor 42 are connected in series, when the current caused to flow through the output portion 40 is large, areas of the first transistor 41 and the second transistor 42 need to be large. In contrast, as being provided in parallel to the first transistor 41 and the second transistor 42, the third transistor 43 added in the present example is capable of causing the same current to flow, even when having an area being approximately a half to a quarter of the areas of the first transistor 41 and the second transistor 42. For this reason, by selecting the size of each of the transistors so that the current flowing through the third transistor 43 is 10 to 100 times larger than the current flowing through the first transistor 41, it is possible to reduce the area of the initial charging circuit 30 within an integrated circuit.

An absolute value of a threshold voltage of the third transistor 43 may be larger than or smaller than the threshold voltages of the first transistor 41 and the second transistor 42. The absolute values of the threshold voltages of the transistors may be equal. Further, the third transistor 43 in the present example is a P type MOSFET; however, the third transistor 43 may be an N type MOSFET. The conductivity-type of the first transistor 41, the conductivity-type of the second transistor 42, and a conductivity-type of the third transistor 43 may all be the same. The third transistor 43 in the present example may be applied to the initial charging circuit 30 in FIG. 2. In other words, the configuration of the resistance portion 50 in FIG. 4 may be the configuration of the resistance portion 50 shown in FIG. 2. With this configuration, it is possible to reduce the area of the initial charging circuit 30 within the integrated circuit. Further, the configuration of the resistance portion 50 in FIG. 4 may be the configuration of the resistance portion 50 shown in FIG. 3. In any other embodiments, the configuration of the resistance portion 50 may be the configuration of the resistance portion 50 in any of FIGS. 2 to 4.

The first resistor 51 may be connected in series to the second transistor 42. The first resistor 51 in the present example is provided between the source of the second transistor 42 and the first power storage element 61. By providing the first resistor 51, it is possible to restrict a lower limit of the resistance value R1 of the resistance portion 50. Accordingly, when a large current is caused to flow through the output portion 40, it is possible to prevent the frequency of the zero point Z1 from becoming too high due to the ON resistance of the second transistor 42 being too small. It is therefore possible to secure stability at the time of having a large current.

The second resistor 52 may be connected in parallel to the second transistor 42. Being connected in parallel to the second transistor 42 may include being connected in parallel only to the second transistor 42 and being connected in parallel to another element (N. B., except for the first transistor 41) connected in series to the second transistor 42. Being connected in parallel only to the second transistor 42 denotes a situation in which one end of the second resistor 52 is connected to the source of the second transistor 42, and another end thereof is connected to the drain of the second transistor 42. The second resistor 52 in the present example is connected in parallel to the second transistor 42 and the first resistor 51 (another element) connected in series to the second transistor 42. As for the second resistor 52 in the present example, one end thereof is connected to the first power storage element 61, and another end thereof is connected to the source of the first transistor 41. When the voltage V1 of the first power storage element 61 decreases, so that the current flowing through the first transistor 41 and the second transistor 42 becomes close to zero, and the second transistor 42 is turned off, the source voltage VFB1 of the first transistor 41 may become unstable. In that situation, because an input voltage of the operational amplifier 32 becomes unstable, there may be situations where the feedback loop may experience a runaway or an oscillation. When the second resistor 52 is provided, even when the second transistor 42 is turned off, VFB1=V1 is true, and the input voltage of the operational amplifier 32 is stable. Thus, it is possible to prevent the runaway or the oscillation of the feedback loop.

To summarize, in the variant shown in FIG. 4, it is possible to efficiently charge the second power storage element 62 in a wide current range according to a wide range of input power, without making the voltage V1 of the first power storage element 61 lower than α×Vref.

A resistance value of the second resistor 52 may be larger than a resistance value of the first resistor 51. Further, although FIG. 4 has all of the third transistor 43, the first resistor 51, and the second resistor 52 provided, it is acceptable to provide any one of these or to provide any two of these.

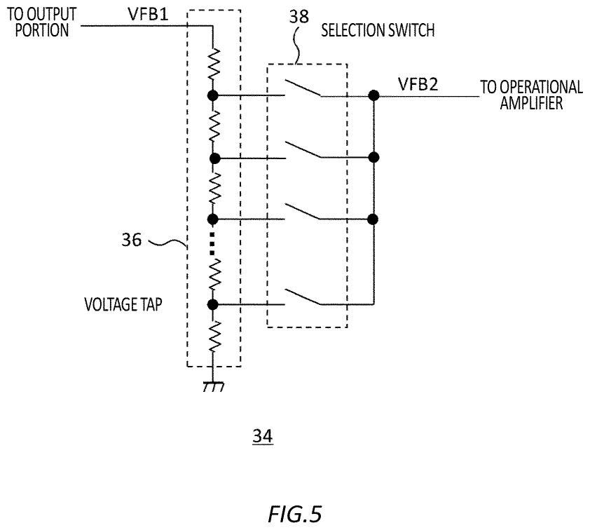

FIG. 5 is a drawing showing a configuration example of the voltage divider circuit 34. The voltage divider circuit 34 in the present example includes a voltage tap 36 and a selection switch 38. The voltage tap 36 includes a plurality of taps among which voltage is divided by a plurality of resistors, as shown in FIG. 5. The selection switch 38 includes a plurality of switches corresponding to the plurality of taps. The plurality of taps are configured to be selected by the switches respectively. Based on a selected tap, a 1/α of the source voltage VFB1 is output as the feedback voltage VFB2. To select the tap, it is desirable to set the voltage of the source voltage VFB1 to become equal to or higher than the operable minimum voltage of the system 80, in a state of being under feedback control. α has a value of a positive real number excluding 0.

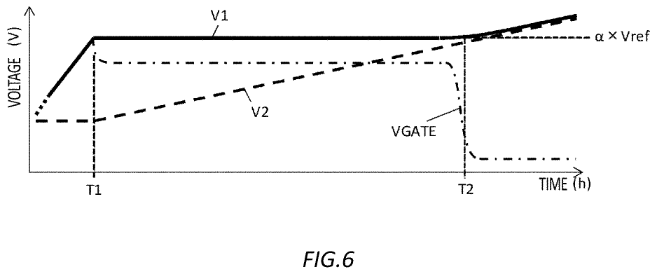

FIG. 6 is a drawing showing an example of temporal changes in each voltage of the energy harvesting device 100 in FIG. 1. When the electrical power from the energy harvesting power supply 10 is supplied, the voltage V1 of the first power storage element 61 quickly increases. Until the voltage V1 reaches α×Vref at a time T1, because the feedback voltage VFB2<the reference voltage Vref is true, no current is supplied to the second power storage element 62, and the voltage V2 of the second power storage element does not increase.

When the voltage V1 reaches α×Vref at the time T1, the feedback loop works so as to realize the feedback voltage VFB2≈the reference voltage Vref. Accordingly, the output voltage VGATE of the operational amplifier 32 decreases, and the voltage V1 is kept at a value equal to or slightly higher than α×Vref. If α×Vref is set to be equal to or higher than the operable minimum voltage of the system 80, the system 80 becomes operable after the time T1. Further, surplus electrical power flows into the second power storage element 62, so that the voltage V2 starts increasing gradually.

When the voltage V2 increases, and a potential difference between the voltage V1 and the voltage V2 becomes small, the absolute value of a drain-source voltage of the first transistor 41 decreases, and a transition is made from the saturation region into a linear region. Because a current does not easily flow in the linear region, the feedback loop lowers the output voltage VGATE so as to decrease the ON resistance between the first power storage element 61 and the second power storage element 62, so that the voltage V1≈V2≈α×Vref is realized at a time T2. After the time T2, V1≈V2>α×Vref is realized. The operational amplifier 32 further lowers the output voltage VGATE, and simultaneously charge both of the first power storage element 61 and the second power storage element 62, so that electrical power is supplied to the system 80 from both of the first power storage element 61 and the second power storage element 62.

In this manner, by using the initial charging circuit 30 of the embodiment, it is possible to quickly charge only the first power storage element 61 and to start up the system 80 without causing ripples from the switching. Further, in the region of V1≈V2>α×Vref after the time T2, the second power storage element 62 is capable of charging and discharging with high efficiency and thus supplies stable electrical power to the system 80.

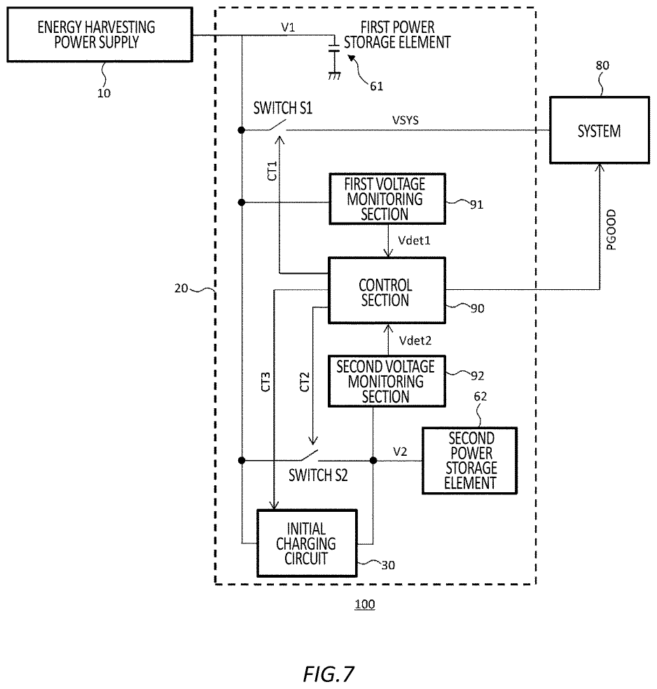

FIG. 7 is a drawing showing another example of the energy harvesting device 100. In the energy harvesting device 100 in the present example, the power feeding apparatus 20 includes a second voltage monitoring section 92. The power feeding apparatus 20 may further include a control section 90. The power feeding apparatus 20 may further include a first voltage monitoring section 91, a switch S1, and a switch S2.

The second voltage monitoring section 92 monitors the voltage V2 of the second power storage element 62. The second voltage monitoring section 92 may directly monitor the output voltage V2 of the second power storage element 62 or may indirectly monitor the output voltage V2 as explained later. The second voltage monitoring section 92 may output an output signal corresponding to the voltage V2. The second voltage monitoring section 92 in the present example outputs a logic signal output Vdet2 to the control section 90 according to a state of the voltage V2 of the second power storage element 62. For example, the second voltage monitoring section 92 outputs Vdet2=“1” when V2>Vth2 and otherwise outputs Vdet2=“0”.

The system 80 may have a plurality of operating modes having different power consumptions. The operating modes include, for example, a mode (a low power mode) to perform a minimum operation such as informing a host computer that electrical power is not sufficient by using a communication function; and a mode (a power consumption mode) in which more electrical power is consumed by acquiring environment data using a sensor or performing complicated signal processing.

According to the output signal of the second voltage monitoring section 92, the power feeding apparatus 20 may output a switch signal PGOOD for switching between the operating modes of the system 80. In the power feeding apparatus 20 in the present example, the control section 90 which received the output signal of the second voltage monitoring section 92 outputs the switch signal PGOOD to inform the system 80 that the second power storage element 62 is valid. The second power storage element 62 being valid may denote that it is possible to sufficiently use electrical power and may denote that V2>Vth2 is true. In other words, the control section 90 may determine whether or not the second power storage element 62 is valid, based on whether or not the second voltage monitoring section 92 is outputting Vdet2=“1”. Note that the logic signal output Vdet2 may directly be output from the second voltage monitoring section 92 to the system 80.

The microcomputer of the system 80 is able to understand from the switch signal PGOOD whether the second power storage element 62 is valid and to determine whether or not a transition is to be made into the operating mode for performing more complicated processing which requires more electrical power. For example, when the switch signal PGOOD is “0” and the second power storage element 62 is not valid, the system 80 is in the low power mode. Thus, it is possible to minimize the electrical power used by the system 80 and to use the surplus electrical power for charging the second power storage element 62. When the switch signal PGOOD is “1” and the second power storage element 62 is valid, it is determined that electrical power is sufficiently supplied to the system 80, and the power consumption mode is carried out.

The switch S1 is provided between the first power storage element 61 and the system 80. To the system 80, a voltage VSYS controlled by the switch S1 is supplied. Between the first power storage element 61 and the second power storage element 62, the switch S2 is provided in parallel to the initial charging circuit 30. The switch S2 and the initial charging circuit 30 in the present example are provided between a connection point of the first power storage element 61 and the system 80, and the second power storage element 62.

The first voltage monitoring section 91 monitors the voltage V1 of the first power storage element 61 and outputs a logic signal output Vdet1 according to a state of the voltage V1. The first voltage monitoring section 91 may be a hysteresis comparator which outputs Vdet1=“1” when V1>Vth1_H, outputs Vdet1=“0” when V1<Vth1_L, and otherwise retains a previous value.

The control section 90 controls operations of the initial charging circuit 30. Based on the logic value of Vdet1 or Vdet2, the control section 90 may output a control signal CT1 for controlling the switch S1 on/off, may output a control signal CT2 for controlling the switch S2 on/off, and may output a control signal CT3 for controlling the initial charging circuit 30 on/off. For example, the control signal CT1 is output based on Vdet1 and turns the switch S1 on when Vdet1=“1” so as to start the power feeding from the first power storage element 61 to the system 80. When the output voltage of the second power storage element 62 becomes higher than a predetermined value, the control section 90 may control the switch S2 into an ON state. The control section 90 may control the switch S2 into the ON state according to the output signal of the second voltage monitoring section 92. For example, the control signal CT2 is output based on Vdet2 and turns the switch S2 on when Vdet2=“1” so as to start the power feeding from the second power storage element 62 to the system 80. The switch S1 and the switch S2 may be transistors.

The initial charging circuit 30 being on denotes that the initial charging circuit 30 is in an operation state corresponding to the voltage V1 as described above. In contrast, the initial charging circuit 30 being off denotes a state in which a current path from the first power storage element 61 to the second power storage element 62 via the output portion 40 of the initial charging circuit 30 is blocked. It is possible to realize the state in which the current path from the first power storage element 61 to the second power storage element 62 is blocked, by connecting the output signal VGATE in FIG. 4, for example, to the voltage V1 of the first power storage element 61 or to the higher voltage being either the voltage V1 or the voltage V2 of the second power storage element 62. As another method for blocking the current path from the first power storage element 61 to the second power storage element 62, it is acceptable to add a switch for cutting the first power storage element 61 from the output portion 40, a switch for cutting the output portion 40 from the second power storage element 62, or a plurality of switches for cutting both. The abovementioned switches may be controlled with the control signal CT3.

Vth1_L may be set to a voltage that makes the system operable and is equal to or higher than a discharge stop voltage of a battery. For example, when a 3.7 V lithium ion battery is used, Vth1_L may be set to 2.9 V, and Vth1_H may be set to a level higher than Vth1_L and equal to or higher than a discharge start voltage of the battery. For example, when a 3.7 V lithium ion battery is used, Vth1_H may be set to 3.3 V. In that situation, α for the initial charging circuit 30 may be set to satisfy α×Vre =Vth1_H=3.3 V, for example, and Vth2 may be set to 3.4 V, for example.

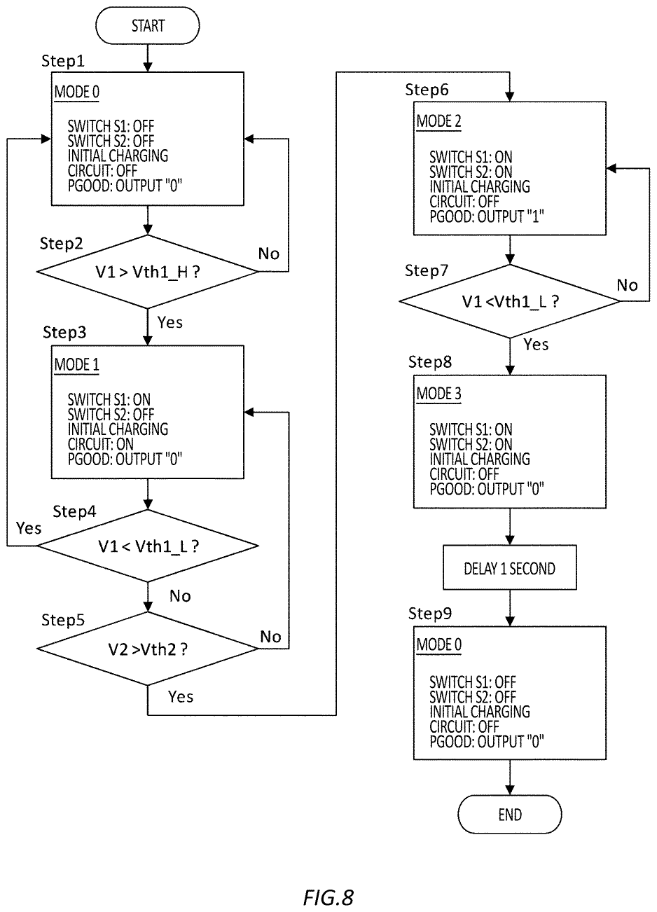

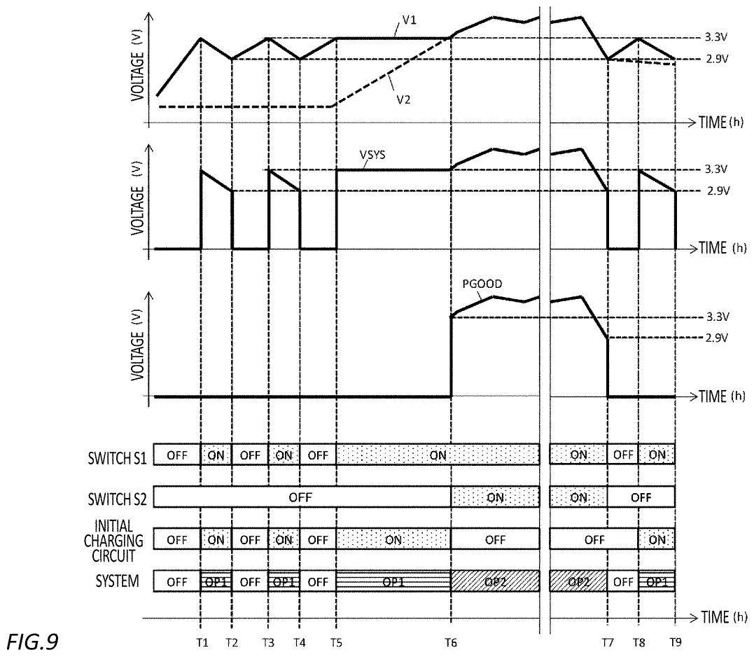

FIG. 8 is a flowchart for explaining an operation of the energy harvesting device 100 in FIG. 7. FIG. 9 is a graph showing temporal changes in voltage of each node and in operations of different parts. Starting from the top, FIG. 9 presents graphs of temporal changes in the voltage V1, the voltage V2, the voltage VSYS, and the switch signal PGOOD. In addition, presented underneath are ON/OFF states of the switch S1, the switch S2, the initial charging circuit 30, and the system 80. Next, operations of the energy harvesting device 100 in FIG. 7 will be explained with reference to FIG. 8 and FIG. 9.

At an operation start point, the voltage V1 of the first power storage element 61 and the voltage V2 of the second power storage element 62 are in the state of being low. This state corresponds to a state of Mode 0 in step 1 of the flowchart in which the switch S1, the switch S2, and the initial charging circuit 30 are all in an OFF state; no voltage is supplied to the system 80; and the second power storage element 62 is in a blocked state.

When electrical power is supplied from the energy harvesting power supply 10, the voltage V1 starts increasing. At the time T1 when the voltage V1 exceeds Vth1_H=3.3 V, the process proceeds to Mode 1 in step 3, according to the determination in step 2 in the flowchart. In Mode 1, the switch S1 turns on, and the initial charging circuit 30 turns on, but the switch S2 is off, and the switch signal PGOOD also outputs 0 V.

Because the switch S1 turns on, the voltage VSYS increases and is supplied to the system 80. At this time, the system 80 starts an operation OP1 of low power (e.g., the low power mode) according to PGOOD=0 V. In the present example, because the electrical power from the energy harvesting power supply 10 is smaller than the electrical power consumed by the system 80, the voltage V1 and the voltage VSYS are gradually decreasing. In addition, because the initial charging circuit 30 does not cause a current to flow through the second power storage element 62 when V1<α×Vref=3.3 V, the voltage V2 of the second power storage element 62 does not change.

When the voltage V1 becomes lower than Vth1_L=2.9 V at the time T2, the process returns to Mode 0 in step 1 according to the determination in step 4, and the switch S1, the switch S2, and the initial charging circuit 30 all return to the OFF state. Because voltage is no longer supplied to the system 80, the voltage V1 starts increasing again. After that, operations from a time T3 to a time T5 are the same as those from the time T1 to the time T3.

At the time T5, the state of Mode 1 in step 3 is achieved. At this time, if the electrical power from the energy harvesting power supply 10 is larger than power consumption of the system 80, the initial charging circuit 30 keeps the voltage V1 at α×Vref=3.3 V and also supplies surplus electrical power to the second power storage element 62, so that the voltage V2 of the second power storage element 62 increases.

At a time T6 when the voltage V2 of the second power storage element 62 exceeds Vth2=3.4 V, the process proceeds to Mode 2 in step 6, according to the determination in step 5. In Mode 2, the switch S2 turns on, the initial charging circuit 30 turns off, and also, the switch signal PGOOD outputs the voltage V1 representing a logic output “1”.

Because the switch S2 is on, charging and discharging from the second power storage element 62 to the first power storage element 61 becomes possible. Thus, electrical power combining the first power storage element 61 and the second power storage element 62 is supplied to the system 80. According to PGOOD=V1(=VSYS), the system 80 becomes able to perform an operation OP2 (e.g., the power consumption mode) using high electrical power.

In Mode 2, the system 80 is stably operated by charging both the first power storage element 61 and the second power storage element 62 when the electrical power supplied from the energy harvesting power supply 10 is large and by discharging from both the first power storage element 61 and the second power storage element 62 when the supplied electrical power is small. FIG. 9 depicts a large gradient for the change in the voltage from the time T6 to a time T7; however, in actuality, because the second power storage element 62 has a large capacity, the change in the voltage is very slow and takes a long period of time.

Although the stable system operation is continued in Mode 2, when the electrical power in the first power storage element 61 and the second power storage element 62 is used up and the voltage V1 becomes lower than Vth1_L=2.9 V at the time T7, the process proceeds to Mode 3 in step 8 according to the determination in step 7 of the flowchart. In Mode 3, while the switch S1 and the switch S2 remain on, the switch signal PGOOD outputs 0 V corresponding to a logic output “0”. From the change in the switch signal PGOOD, the system 80 senses that the remaining capacity of the second power storage element 62 is getting low and performs necessary processes such as appropriately ending an operation presently being executed and having data saved in a non-volatile memory.

After the process proceeds to step 8, when a predetermined delay period has elapsed, the process proceeds to Mode 0 in step 9 and returns to the initial state. The delay period in the present example is 1 second. The delay period from step 8 to step 9 may be longer than or shorter than 1 second, in consideration of the time required by the processes executed by the system 80. Mode 3 is not shown in FIG. 9, because the lasting period thereof is short.

After the time T7 in FIG. 9, the process returns to step 1 at the beginning of the flowchart. A time T8 and a time T9 are the same as the time T1 and the time T2, respectively. In this manner, the energy harvesting device 100 in FIG. 7 is able to realize the stable operation by using only the energy harvesting power supply 10, without requiring an external power supply or a coin electric cells, an AA battery, or the like which requires an electric cell replacement.

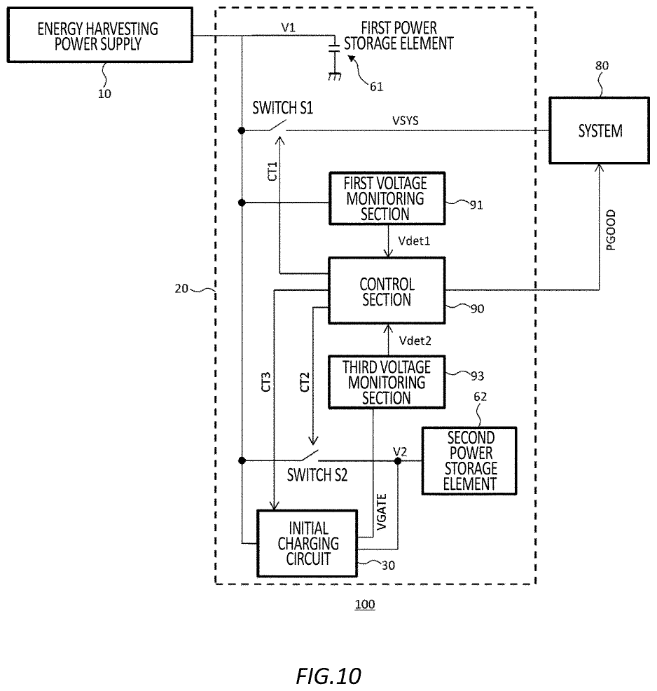

FIG. 10 is a drawing showing a variant of the energy harvesting device 100 shown in FIG. 7. In the energy harvesting device 100 in the present example, the power feeding apparatus 20 includes a third voltage monitoring section 93, in place of the second voltage monitoring section 92. The third voltage monitoring section 93 monitors the output voltage VGATE of the operational amplifier 32 of the initial charging circuit 30.

In the example in FIG. 7, the operating mode of the system 80 is switched by monitoring the voltage V2 of the second power storage element 62. As shown in FIG. 6, when the voltage V1 of the first power storage element 61 and the voltage V2 of the second power storage element 62 both reach α×Vref, the output voltage VGATE of the operational amplifier 32 of the initial charging circuit 30 rapidly decreases. For this reason, as shown in FIG. 10, it is also acceptable to provide the third voltage monitoring section 93 which monitors whether the output voltage VGATE, instead of the voltage V2, has decreased to a level equal to or lower than a predetermined voltage. The third voltage monitoring section 93 may output an output signal corresponding to the output voltage VGATE. The third voltage monitoring section 93 in the present example outputs the logic signal output Vdet2 corresponding to the output voltage VGATE to the control section 90.

The power feeding apparatus 20 may output a switch signal for switching between the operating modes of the system 80, according to the output voltage VGATE of the operational amplifier 32. According to the logic signal output Vdet2, the power feeding apparatus 20 may output a switch signal for switching between the operating modes of the system 80. In the power feeding apparatus 20 in the present example also, the control section 90 outputs the switch signal PGOOD to inform the system 80 that the second power storage element 62 is valid. In the present example, whether or not the second power storage element 62 is valid may be determined based on whether or not the output voltage VGATE has decreased to a level equal to or lower than a predetermined voltage. Note that the logic signal output Vdet2 may directly be output from the third voltage monitoring section 93 to the system 80.

In the example in FIG. 7, the timing of the transition to Mode 2 in the flowchart is realized by monitoring the voltage V2 of the second power storage element 62; however, in the present example, the timing of the transition to Mode 2 may be determined by monitoring the output voltage VGATE. For example, the transition to Mode 2 may be made with timing at which the output voltage VGATE becomes lower than a predetermined value. When the output voltage VGATE of the operational amplifier 32 becomes lower than a predetermined value, the control section 90 may control the switch S2 into an ON state. The control section 90 may control the switch S2 into the ON state according to the output signal of the third voltage monitoring section 93. With this configuration also, it is possible to establish a connection between the first power storage element 61 and the second power storage element 62 with a low resistance.

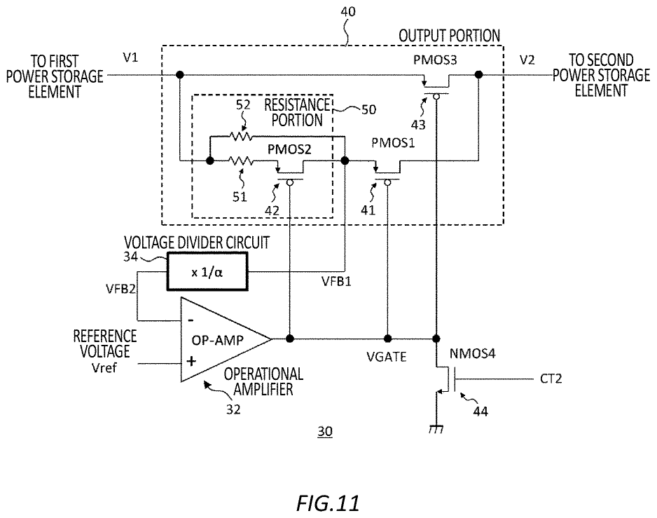

FIG. 11 is a drawing showing a variant of the initial charging circuit 30. The initial charging circuit 30 in the present example includes a fourth transistor 44, in addition to the configuration of the initial charging circuit 30 shown in FIG. 4. The fourth transistor 44 in the present example is an N type MOSFET. One end (a drain) of the fourth transistor 44 is connected to an output of the operational amplifier 32. Another end (a source) of the fourth transistor 44 is connected to a ground (0 V). In other words, the drain of the fourth transistor 44 is connected to gates of the first transistor 41, the second transistor 42, and the third transistor 43.

A gate of the fourth transistor 44 is connected to the control section 90 in FIG. 7, and the control signal CT2 is input thereto. When the voltage V2 of the second power storage element 62 becomes higher than a predetermined value, the control section 90 may control the third transistor 43 of the initial charging circuit 30 into an ON state. The control section 90 may control the third transistor 43 into the ON state according to an output signal of the second voltage monitoring section 92. In the present example, upon receipt of Vdet2=“1” from the second voltage monitoring section 92, the control section 90 adjusts the control signal CT2 and brings the fourth transistor 44 into an ON state. As a result, the third transistor 43 turns into an ON state. Accordingly, a connection between the first power storage element 61 and the second power storage element 62 is established with a low resistance. At this time, the first transistor 41 may be controlled into an OFF state or may be controlled into an ON state. Similarly, the second transistor 42 may be controlled into an OFF state or may be controlled into an ON state. Further, at this time, it is desirable that the operational amplifier 32 is turned off. In other words, in the example in FIG. 7, the switch S2 is provided in parallel to the initial charging circuit 30; however, in the present example, the output portion 40 of the initial charging circuit 30 is used as the switch S2. When the voltage V2 of the second power storage element 62 becomes higher than a predetermined value, the control section 90 may control the first transistor 41 of the initial charging circuit 30 into an ON state and may control the second transistor 42 into an ON state. At this time, the third transistor 43 may be controlled into an OFF state or may be controlled into an ON state.

As shown in FIG. 10, the power feeding apparatus 20 may include the third voltage monitoring section 93, in place of the second voltage monitoring section 92. In that situation, the control section 90 may control the third transistor into an ON state, based on the output voltage VGATE of the operational amplifier 32 shown in FIG. 10, instead of the abovementioned voltage V2 of the second power storage element 62. When the output voltage VGATE of the operational amplifier 32 becomes lower than a predetermined value, the control section 90 may control the third transistor into the ON state. The control section 90 may control the third transistor 43 into the ON state according to an output signal of the third voltage monitoring section 93. The control section 90 may control the third transistor 43 into the ON state, by adjusting the control signal CT2 and controlling the fourth transistor 44 into an ON state. With this configuration also, it is possible to establish a connection between the first power storage element 61 and the second power storage element 62 with a low resistance.

The fourth transistor 44 may be provided in the initial charging circuit 30 in any of FIG. 2 to FIG. 4. The fourth transistor 44 may be a P type MOSFET. A conductivity-type of the fourth transistor 44 may be the same as or may be different from conductivity-types of other transistors. Further, the initial charging circuit 30 in the present example may be provided for the energy harvesting device 100 shown in FIG. 10. In that situation, the control section 90 acquires a state of the voltage V2 of the second power storage element 62 from the third voltage monitoring section 93.

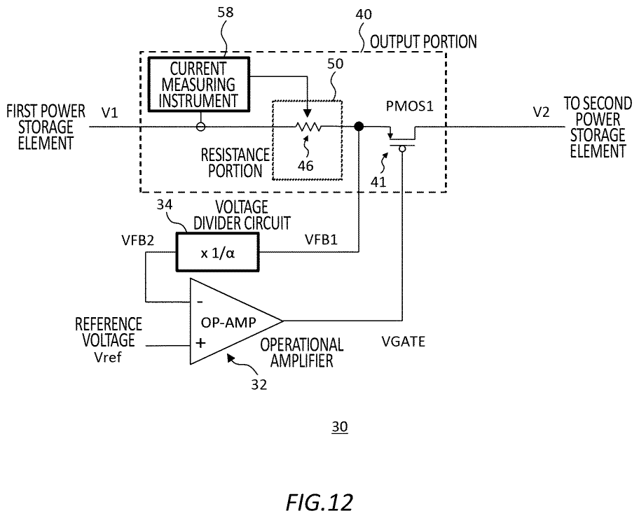

FIG. 12 is a drawing showing another variant of the initial charging circuit 30. The output portion 40 in the present example includes a current measuring instrument 58. Further, the resistor 46 in the resistance portion 50 in the present example is a variable resistor. The other features may be the same as those in FIG. 2.

The current measuring instrument 58 measures a current flowing through the resistance portion 50. Based on a current value measured by the current measuring instrument 58, a resistance value of the resistance portion 50 is controlled. In FIG. 12, the current measuring instrument 58 measures a current value at a connection point of the resistance portion 50 and the first power storage element 61; however, it is also acceptable to measure a current value at a connection point of the resistance portion 50 and the first transistor 41 or a current value at a connection point of the first transistor 41 and the second power storage element 62. A control signal input to the resistance portion 50 from the current measuring instrument 58 may be an analog signal that continuously changes or may be a digital signal having discrete values. The resistor 46 may be an analog variable resistor such as a voltage-controlled variable resistor, for example, or may be a digital variable resistor configured with an array of a resistor and a switch. For example, the voltage-controlled variable resistor is a transistor whose one end is connected to the first power storage element 61 and whose another end is connected to one end of the first transistor 41. A gate terminal of this transistor is connected to the current measuring instrument 58, and a control signal is input thereto. Further, for example, control is exercised in such a manner that the resistance value is reduced when the measured current value is large, and conversely, the resistance value is increased when the measured current value is small. With this configuration, it is possible to secure stability of the feedback loop and to also prevent degradation of the charging efficiency which may be caused by a voltage drop. The resistance portion 50 and the current measuring instrument 58 in the present example may be applied to the initial charging circuit 30 in any of FIG. 2 to FIG. 4 or FIG. 11. For example, the resistance portion 50 may include the resistor 46 and the second transistor 42 in the present example and may include the resistor 46 in the present example in place of the second transistor 42.

While the present invention has been described by way of the embodiments, the technical scope of the present invention is not limited to the above-described embodiments. It is apparent to persons skilled in the art that various alterations or improvements can be made to the above described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An initial charging circuit which controls a current flowing between a first power storage element to be charged with electrical power from an energy harvesting power supply and a second power storage element having a larger capacity than the first power storage element and to be charged with electrical power from the first power storage element,
the initial charging circuit comprising:
a resistance portion whose one end is connected to the first power storage element;
a first transistor whose one end is connected to another end of the resistance portion and whose another end is connected to the second power storage element; and
an operational amplifier whose output terminal is connected to a control terminal of the first transistor and which varies an amount of current flowing between the first power storage element and the second power storage element, based on a difference between a reference voltage and a voltage at a node between the one end of the first transistor and the another end of the resistance portion.

2. The initial charging circuit according to claim 1, wherein
a resistance value of the resistance portion when a current flowing through the resistance portion has a first amount of current is smaller than a resistance value of the resistance portion when the current flowing through the resistance portion has a second amount of current smaller than the first amount of current.

3. The initial charging circuit according to claim 1, wherein
the resistance portion includes a second transistor, and
the output terminal of the operational amplifier is connected to a control terminal of the second transistor, and the operational amplifier varies an ON resistance of the second transistor, based on the difference between the reference voltage and the voltage at the node between the one end of the first transistor and the another end of the resistance portion.

4. The initial charging circuit according to claim 3, wherein
an absolute value of a threshold voltage of the second transistor is larger than an absolute value of a threshold voltage of the first transistor.

5. The initial charging circuit according to claim 1, wherein
the initial charging circuit comprises a third transistor whose one end is connected to the first power storage element and whose another end is connected to the second power storage element and which is connected in parallel to the first transistor and the resistance portion, and
an output of the operational amplifier is connected to a control terminal of the third transistor, and the operational amplifier varies the amount of current flowing between the first power storage element and the second power storage element, based on the difference between the reference voltage and the voltage at the node between the one end of the first transistor and the another end of the resistance portion.

6. The initial charging circuit according to claim 3, wherein
the resistance portion includes a first resistor connected in series to the second transistor.

7. The initial charging circuit according to claim 3, wherein
the resistance portion includes a second resistor connected in parallel to the second transistor.

8. A power feeding apparatus comprising:
the initial charging circuit according to claim 1;
the first power storage element; and
the second power storage element, wherein
at least one of the first power storage element or the second power storage element supplies electrical power to a system existing externally.

9. The power feeding apparatus according to claim 8, comprising:
a voltage monitoring section which monitors an output voltage of the second power storage element and outputs an output signal corresponding to the output voltage, wherein
according to the output signal, the power feeding apparatus outputs a switch signal for switching the system into an operating mode having a different power consumption.

10. The power feeding apparatus according to claim 8, comprising:
a voltage monitoring section which monitors an output voltage of the operational amplifier and outputs an output signal corresponding to the output voltage, wherein
according to the output signal, the power feeding apparatus outputs a switch signal for switching the system into an operating mode having a different power consumption.

11. A power feeding apparatus comprising:
the initial charging circuit according to claim 5;
the first power storage element;
the second power storage element;
a voltage monitoring section which monitors an output voltage of the second power storage element; and
a control section which controls the initial charging circuit, wherein
at least one of the first power storage element or the second power storage element supplies electrical power to a system existing externally, and
the control section controls the third transistor of the initial charging circuit into an ON state, when the output voltage becomes higher than a predetermined value.

12. The power feeding apparatus according to claim 11, wherein
the initial charging circuit includes a fourth transistor whose one end is connected to an output of the operational amplifier and whose another end is connected to a ground, and
when the output voltage becomes higher than the predetermined value, the control section controls the third transistor into the ON state, by controlling the fourth transistor into an ON state.

13. A power feeding apparatus comprising:
the initial charging circuit according to claim 5;
the first power storage element;
the second power storage element;
a voltage monitoring section which monitors an output voltage of the operational amplifier; and
a control section which controls the initial charging circuit, wherein
at least one of the first power storage element or the second power storage element supplies electrical power to a system existing externally, and
the control section controls the third transistor of the initial charging circuit into an ON state, when the output voltage becomes lower than a predetermined value.

14. The power feeding apparatus according to claim 13, wherein
the initial charging circuit includes a fourth transistor whose one end is connected to an output of the operational amplifier and whose another end is connected to a ground, and
when the output voltage becomes lower than the predetermined value, the control section controls the third transistor into the ON state, by controlling the fourth transistor into an ON state.

15. The power feeding apparatus according to claim 8 comprising:
a voltage monitoring section which monitors an output voltage of the second power storage element;
a control section which controls the initial charging circuit; and
a switch connected, between the first power storage element and the second power storage element, in parallel to the initial charging circuit, wherein
the control section controls the switch into an ON state, when the output voltage becomes higher than a predetermined value.

16. The power feeding apparatus according to claim 8, comprising:
a voltage monitoring section which monitors an output voltage of the operational amplifier;
a control section which controls the initial charging circuit; and
a switch connected, between the first power storage element and the second power storage element, in parallel to the initial charging circuit, wherein
the control section controls the switch into an ON state, when the output voltage becomes lower than a predetermined value.

17. An energy harvesting device comprising:
the power feeding apparatus according to claim 8;
the system; and
the energy harvesting power supply.

18. A power feeding apparatus comprising:
the initial charging circuit according to claim 2;
the first power storage element; and
the second power storage element, wherein
at least one of the first power storage element or the second power storage element supplies electrical power to a system existing externally.

19. A power feeding apparatus comprising:
the initial charging circuit according to claim 3;
the first power storage element; and
the second power storage element, wherein
at least one of the first power storage element or the second power storage element supplies electrical power to a system existing externally.

20. A power feeding apparatus comprising:
the initial charging circuit according to claim 4;
the first power storage element; and
the second power storage element, wherein
at least one of the first power storage element or the second power storage element supplies electrical power to a system existing externally.
